(19) United States
(12) Patent Application Publication
(10) Pub. No.: US 2026/0360789 A1
(43) Pub. Date: Nov. 12, 2026

(54) CARBON FIBER BASED ADDITIVE MANUFACTURING STRUCTURAL BATTERY

(71) Applicants: Jonghyun Park, Rolla, MO (US); Jacob Sutton, Rolla, MO (US)

(72) Inventors: Jonghyun Park, Rolla, MO (US); Jacob Sutton, Rolla, MO (US)

(73) Assignee: The Curators of the University of Missouri, Columbia, MO (US)

(21) Appl. No.: 19/178,274

(22) Filed: Apr. 14, 2025

Related U.S. Application Data
(60) Provisional application No. 63/633,508, filed on Apr. 12, 2024.

(51) Int. Cl. H01M 10/04; B33Y 80/00; D06M 11/74; D06M 11/84; D06M 15/31; D06M 15/71; D06M 101/40

(52) U.S. Cl. CPC H01M 10/04; D06M 11/74; D06M 11/84; D06M 15/31; D06M 15/71; B33Y 80/00; D06M 2101/40

(57) ABSTRACT

Methods of preparing a structural battery component are provided. The structural battery component has a carbonized carbon fiber material and is assembled by forming spaced holes in the anode, cathode, and separator material and injecting a binding material into the spaced holes. Methods of preparing a structural battery are also provided. The structural battery is assembled by forming spaced holes in one or more structural battery components and injecting a binding material into the spaced holes.

### CROSS REFERENCE TO RELATED APPLICATIONS

This application claims priority to U.S. Provisional Patent Application No. 63/633,508, filed Apr. 12, 2024, the entire disclosure of which is incorporated herein by reference.

### FIELD

Provided herein are methods for preparing structural battery components and structural batteries. Also provided herein are structural battery components and structural batteries comprising spaced holes with binding material disposed therein.

### BACKGROUND

Structural batteries are multifunctional structures which can act as an energy storage system while maintaining mechanical integrity of the system to which they provide power. There are numerous and varying applications for structural batteries. For example, structural batteries are used in drones, electric vehicles, and modern electronic portable devices.

However, structural batteries typically suffer from poor mechanical properties. Therefore, there is necessarily a trade-off between the mechanical properties and battery performance of the structural batteries.

Previous attempts to overcome poor mechanical properties of structural batteries typically comprised the use of mechanically strong materials, such as carbon fiber reinforced polymers. However, use of these materials resulted in hindrance of the electronic path of the electrodes due to the high percentage of non-conductive polymer materials.

Therefore, a need exists for new and improved structural batteries and methods of construction thereof, wherein the materials simultaneously provide for good mechanical properties (e.g., strength) and an effective electronic path for the electrodes.

### BRIEF SUMMARY

One aspect of the present disclosure is directed to a method for preparing a structural battery component. The method comprises preparing an anode and a cathode and assembling the structural battery component. Each of the anode and cathode are electrodes prepared by: placing a carbonizable material on at least one surface of a carbon fiber material, thereby forming an intermediate carbon fiber material; carbonizing the intermediate carbon fiber material, thereby forming a carbonized carbon fiber material; and placing an electrode active material on at least one surface of the carbonized carbon fiber material, thereby forming the electrode. Assembling the structural battery component comprises: forming spaced holes in the anode, the cathode, and a separator material; placing the separator material between the anode and the cathode to form an intermediate structural battery component; and injecting a binding material into the spaced holes of the intermediate structural battery component to form the structural battery component.

Further aspects of the present disclosure are directed to a method for preparing a structural battery. The method comprises providing two or more structural battery components; forming spaced holes in each of the two or more structural battery components; stacking the two or more structural battery components such that at least one surface of each structural battery component is in contact with at least one surface of another structural battery component, thereby forming a stacked assembly; injecting a binding material into the spaced holes of each of the two or more structural battery components; and placing the stacked assembly within an enclosure, thereby forming the structural battery.

Still further aspects of the present disclosure are directed to a structural battery. The structural battery comprises two or more structural battery components within an enclosure. Each structural battery component comprises: an anode, a cathode, and a separator material, wherein the separator material is between the anode and cathode. The anode, the cathode, and the separator material each comprise spaced holes having a binding disposed material therein.

Other objects and features will be in part apparent and in part pointed out hereinafter.

### BRIEF DESCRIPTION OF THE FIGURES

FIG. 1 illustrates one method for forming a structural battery component.

FIG. 2 illustrates a cross-sectional view of one embodiment of the structural battery component.

FIG. 3 illustrates one or more structural battery components placed within an enclosure.

FIG. 4A shows the SEM imaging results for a carbon fiber mat that was not treated with a layer of carbonizable material prior to casting the active material onto each carbon fiber mat.

FIG. 4B shows the SEM imaging results for a carbon fiber mat that was treated with a layer of carbonizable material prior to casting the active material onto each carbon fiber mat.

FIGS. 5A and 5B show electrodes of one embodiment, with FIG. 5A showing the anode comprising MCMB and FIG. 5B showing the cathode comprising LMO.

FIG. 6 shows an assembled wing cell structural battery.

FIG. 7A shows the discharge voltage of two structural batteries.

FIG. 7B shows the specific discharge capacity of bonded and unbonded structural batteries.

FIG. 8 shows the specific discharge capacity of a “coated” structural battery vs. an “uncoated” structural battery.

Corresponding reference characters indicate corresponding parts throughout the drawings.

### DETAILED DESCRIPTION

A “structural battery” is term generally used to refer to a material that is capable of storing electrical energy, while simultaneously having a certain level of mechanical integrity (e.g., being able to withstand a mechanical load). In this way, the battery may be used to form a part of the structure or support of the device to which the battery is incorporated.

Certain exemplary applications of structural batteries are in electrical vehicles, and mobile electronic devices. In an electrical vehicle, for example, the structural battery may be used not only as a source of electrical energy storage, but also act as a portion of the vehicle frame or act in support of the vehicle frame. Particularly in the context of an electrical vehicle, a battery may represent a large component of the vehicles overall weight. By using a structural battery, it is possible to support at least a portion of the vehicle with this heavy battery and remove or reduce the overall weight of the other supporting components that would typically be necessary in the absence of such a structural battery providing support. In this way, the total weight of the electrical vehicle can be minimized.

Similar considerations are present when utilizing a structural battery in a drone. The length of time that a drone may be airborne is a function of the overall drone weight and the electrical energy capacity of the battery present in the drone. By using a structural battery to simultaneously store electrical energy and provide support to the overall frame of the drone, it is possible to increase the percentage of the total drone weight that is directly attributable to the electrical energy capacity. Thus, the drone may be able to remain airborne for a longer period of time, as compared to a drone having a comparable weight but not utilizing a structural battery.

Although certain specific applications of structural batteries are discussed herein, it will be understood that the structural batteries described herein may be useful in any context that requires the storage of electrical energy or a battery component.

Previous attempts at forming structural batteries typically comprised the addition of carbon fibers as both a load carrying material and an active battery electrode in the battery. No previous structural battery utilized the additive manufacturing based approach that is discussed herein or formed a structural battery as described. For example, previous configurations employing carbon fiber were limited to a single geometry, such as a planar or simple layered configuration. Other configurations employing carbon fiber as a structural reinforcing element as well as a current collector were limited specifically to planar geometries.

In contrast, the present disclosure provides for unique, highly versatile (including in any geometry desired) structural battery configurations and methods of preparing such structural batteries that allow the technology of structural batteries to be used across a range of different application and physical constraints regarding the use of batteries.

Certain embodiments of the present disclosure are directed to a structural battery comprising two or more structural battery components (e.g., layers) within an enclosure. For example, some embodiments of the present disclosure are directed to additive manufactured structural batteries comprising stacking or assembling a plurality of structural battery components (i.e. structural battery layers) to form the structural battery.

In some embodiments, each of the plurality of structural battery components comprise an anode, a cathode, and a separator material. That is, the assembled structural battery comprises a plurality of structural battery component layers wherein each layer forms a single cell of the battery. In this way, it is possible to utilize additive manufacturing and assemble the structural battery using a discrete number of structural battery component layers suitable for the intended application of the structural battery.

One embodiment of the present disclosure is directed to methods for preparing a structural battery component. While the term “structural battery component” is used throughout, it will be understood that this term may be interchangeable in certain contexts with the described additive manufacturing wherein each structural battery component forms a layer of the structural battery.

In certain embodiments, a structural battery component comprises an anode, a cathode, and a separator material. In certain embodiments, the anode and cathode may be prepared by a similar method (wherein each of the anode and cathode are referred to generally as an “electrode”).

In one embodiment, the method for preparing a structural battery component comprises preparing an anode and a cathode, wherein each of the anode and cathode are electrodes prepared by providing a carbon fiber material, a carbonizable material, and an electrode active material. The method comprises placing the carbonizable material on at least one surface of the carbon fiber material, thereby forming an intermediate carbon fiber material. The intermediate carbon fiber material is then carbonized, thereby forming a carbonized carbon fiber material. Finally, the electrode active material is placed on at least one surface of the carbonized carbon fiber material, thereby forming the electrode.

In certain embodiments, the carbon fiber material is a material selected from the group consisting of fabric, veils, braids, sheets, mats, and combinations thereof comprising carbon fiber. In certain embodiments, the carbon fiber material is a woven fabric comprising carbon fiber. In some embodiments, the woven fabric comprising carbon fiber is selected from the group consisting of satin weave, twill weave, plain weave, or combinations thereof. In one embodiment, the carbon fiber material is a carbon fiber mat or sheet.

In various embodiments, the carbon fiber material may be selected from the group consisting of ultra-high modulus carbon fiber material, high modulus carbon fiber material, intermediate modulus carbon fiber material, low modulus, super high tensile carbon fiber material, or combinations thereof. In some embodiments, the carbon fiber material is selected from the group consisting of PAN-based carbon fiber material, isotropic pitch-based carbon fiber material, rayon-based carbon fiber material, gas-phase-grown carbon fiber material, mesosphere pitch-based carbon fiber material, or combinations thereof.

The carbon fiber material of the anode may be the same or different from the carbon fiber material of the cathode.

The carbonizable material applied to or placed on at least one surface of the carbon fiber material may be any material suitable for carbonization. In certain embodiments, the carbonizable material is selected from the group consisting of polyvinyl alcohol, polyvinyl acetate, polyethylene oxide, polyvinyl ether, polyvinylpyrrolidone, polyglycolic acid, polyvinylidene difluoride, polyacrylonitrile (PAN), polyacrylic acid, polymethylmethacrylate, and combinations thereof. In one embodiment, the carbonizable material comprises PAN.

In certain embodiments, the carbonizable material is a solution comprising a solvent. The solvent may be any solvent suitable for use in subsequent carbonization procedures. For example, in certain embodiments, the solvent is selected such that the solvent is substantially removed (e.g., evaporated) following carbonization. In some embodiments, the solvent is selected from the group consisting of N-methyl-2-pyrrolidone (NMP), dimethylformamide (DMF), water, and combinations thereof. However, any suitable solvent may be used.

In one embodiment, the carbonizable material is a solution comprising PAN and DMF.

The carbonizable material used on the anode may be the same or different from the carbonizable material used on the cathode.

In some embodiments, the intermediate carbon fiber material formed by placing a carbonizable material on at least one surface of a carbon fiber material is dried prior to carbonization. For example, the intermediate carbon fiber material may be dried at a temperature of at least about 40 °C, at least about 50 °C, at least about 60 °C, at least about 70 °C, at least about 80 °C, at least about 90 °C, at least about 100 °C, at least about 125 °C, at least about 150 °C, at least about 175 °C, at least about 200 °C, at least about 225 °C, at least about 250 °C, at least about 275 °C, at least about 300 °C, at least about 325 °C, at least about 350 °C, at least about 375 °C, or at least about 400 °C. In certain embodiments, the intermediate carbon fiber material may be dried at a temperature of from about 40 °C to about 400 °C, from about 50 °C to about 400 °C, from about 60 °C to about 70 °C, from about 80 °C to about 400 °C, from about 90 °C to about 400 °C, from about 100 °C to about 400 °C, from about 100 °C to about 350 °C, from about 100 °C to about 300 °C, from about 100 °C to about 250 °C, or from about 150 °C to about 250 °C. In various embodiments, the carbon fiber material may be dried under vacuum. The drying period may be for any suitable period of time and may comprise one or more drying conditions. For example, a period of drying at 200 °C, followed by a period of drying under vacuum. Where multiple drying conditions are used, the period of each drying condition may be the same or different. The drying periods may be, for example, about 30 minutes or more, about 45 minutes or more, about 1 hour or more, about 2 hours or more, about 3 hours or more, about 4 hours or more, about 5 hours or more, or about 10 hours or more.

In certain embodiments, the intermediate carbon fiber material (whether or not subjected to the drying discussed in detail above) may be carbonized.

The carbonization conditions may be any conditions suitable to conduct carbonization of one or more of the organic materials present in the intermediate carbon fiber material (e.g., from the carbonizable material). In some embodiments, carbonization of the intermediate carbon fiber material is conducted at a temperature of at least about 300 °C, at least about 325 °C, at least about 350 °C, at least about 375 °C, at least about 400 °C, at least about 450 °C, at least about 500 °C, at least about 550 °C, at least about 600 °C, at least about 650 °C, at least about 700 °C, at least about 750 °C, at least about 800 °C, at least about 850 °C, at least about 900 °C, at least about 950 °C, at least about 1,000 °C, at least about 1,100 °C, at least about 1,200 °C, at least about 1,300 °C, at least about 1,400 °C, or at least about 1,500 °C. In other embodiments the carbonization is conducted at a temperature of from about 400 °C to about 2,000 °C, from about 500 °C to about 2,000 °C, from about 600 °C to about 2,000 °C, from about 700 °C to about 2,000 °C, from about 800 °C to about 2,000 °C, from about 900 °C to about 2,000 °C, or from about 1,000 °C to about 2,000 °C.

The carbonization may be conducted for any suitable period of time to carbonize the one or more of the organic materials present in the intermediate carbon fiber material (e.g., from the carbonizable material). For example, the carbonization may be conducted for a period of for a period of about 15 minutes or greater, about 30 minutes or greater, about 45 minutes or greater, about 1 hour or greater, about 2 hour or greater, about 3 hour or greater, about 4 hour or greater, or about 5 hour or greater.

In some embodiments, the intermediate carbon fiber material is carbonized in an inert environment. For example, in a nitrogen purged environment.

In various embodiments, following carbonization of the intermediate carbon fiber material, an electrode active material is applied to at least one surface of the carbonized carbon fiber material. In other embodiments, following drying and carbonization of the intermediate carbon fiber material, an electrode active material is applied to at least one surface of the carbonized carbon fiber material.

The electrode active material may be any convention electrode active material. In certain embodiments, the electrode active material is selected from the group consisting of lithium manganese oxide (LMO), lithium nickel manganese cobalt oxide (NMC), lithium iron phosphate (LFP), mesocarbon microbeads (MCMB), polyvinylidene fluoride (PVDF), carboxymethyl cellulose (CMC) binder, styrene butadiene rubber (SBR), carbon black, and combinations thereof. For example, in certain embodiments, the lithium nickel manganese cobalt oxide may comprise NMC811.

In various embodiments, the electrode active material applied to at least one surface of the carbonized carbon fiber material may comprise a solvent. In such cases, the method of preparing the electrode may further comprise removing the solvent (e.g., by evaporation in a vacuum) after application of the electrode active material.

In some embodiments, the solvent is selected from the group consisting of N-methyl-2-pyrrolidone (NMP), dimethylformamide (DMF), water, and combinations thereof. However, any suitable solvent may be used.

It will be understood that the electrode active material applied to the carbonized carbon fiber material will depend to a certain extent on the composition of the carbonized carbon fiber material and the nature of the electrode (e.g., whether the electrode is an anode or a cathode).

In certain embodiments, the electrode is an anode and the electrode active material is selected from the group consisting of lithium manganese oxide (LMO), lithium nickel manganese cobalt oxide (NMC), lithium iron phosphate (LFP), mesocarbon microbeads (MCMB), polyvinylidene fluoride (PVDF), carboxymethyl cellulose (CMC) binder, styrene butadiene rubber (SBR), carbon black, and combinations thereof. In one embodiment, the electrode is an anode and the electrode active material comprises MCMB.

In other embodiments, the electrode is a cathode and the electrode active material is selected from the group consisting of lithium manganese oxide (LMO), lithium nickel manganese cobalt oxide (NMC), lithium iron phosphate (LFP), mesocarbon microbeads (MCMB), polyvinylidene fluoride (PVDF), carboxymethyl cellulose (CMC) binder, styrene butadiene rubber (SBR), carbon black, and combinations thereof. In one embodiment, the electrode is a cathode and the electrode active material comprises LMO.

Various embodiments of the present disclosure are directed to a method of preparing a structural battery component comprising an anode, a cathode, and a separator material. In certain embodiments, the method for preparing structural battery component comprises preparing an anode and a cathode (e.g., as described above), providing a separator material, and assembling the structural battery component. In one embodiment, assembling the structural battery component comprises placing the separator material between the anode and the cathode.

Certain specific embodiments of the present disclosure are directed to a method of assembling a structural battery component comprising forming one or more holes in each of the anode, the cathode, and the separator material; placing the separator material between the anode and the cathode to form an intermediate structural battery component; and injecting a binding material into the one or more holes of the intermediate structural battery component to form the structural battery component. Other embodiments are directed to forming one or more holes in each of the anode, the cathode, and the separator material; injecting a binding material into the one or more holes; and placing the separator material between the anode and the cathode to form the structural battery component.

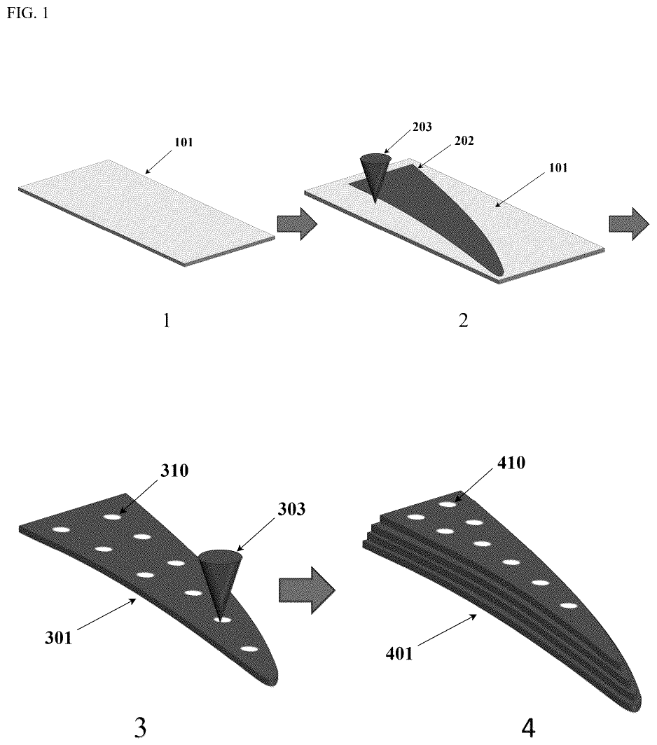

Referring now to FIG. 1, one embodiment of the present method is illustrated. In Step 1, sheet 101 corresponds generally to any of the anode, cathode, or separator material discussed above. In Step 2, a pattern 202 of the desired shape of the structural battery component is placed on the sheet 101 and a cutting device 203 is used to cut a portion of the sheet 101 into the desired shape. In the embodiment of FIG. 1, cutting device 203 corresponds to a femtosecond laser. Next, in Step 3, a number of holes 310 are made in the shaped sheet (i.e. the portion of sheet 101 cut into the desired shape that is formed in Step 2), thereby forming a sheet 301 having holes therein. A cutting device 303 is used to form the holes 310. In the embodiment of FIG. 1, the holes are formed using a femtosecond laser. Steps 1-3 are repeated for each of the anode, cathode, and separator material. That is, a separate sheet as shown at 301 is prepared for the anode, the cathode, and the separator material. In Step 4, the separator material sheet having holes therein is placed between the anode sheet having holes therein and the cathode sheet having holes therein. An assembled structure 401 is formed, wherein the holes 410 traverse the entire width/height of the assembled structure 410. A binding material is then placed within each of the holes 410 to bind the layers of the assembled structure 410 and enhance structural integrity and improve bonding between layers, thereby forming the structural battery component.

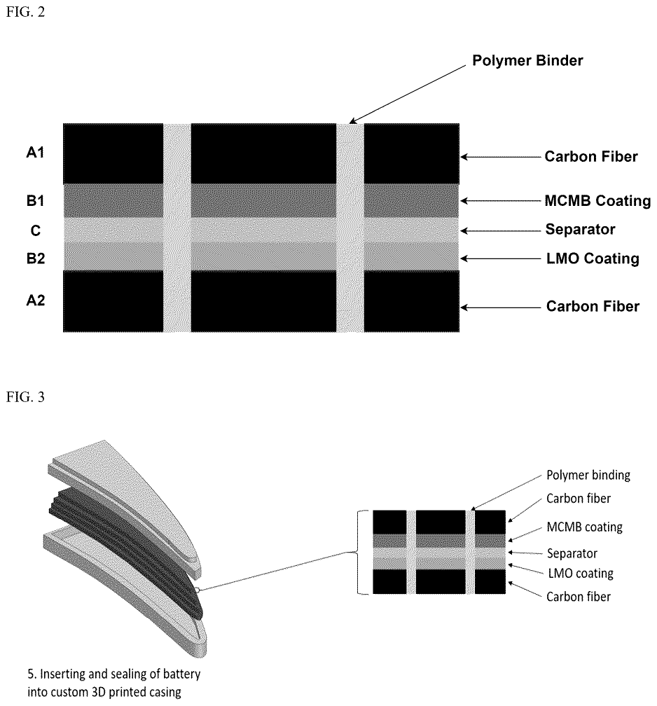

FIG. 2 illustrates a cross-sectional view of one embodiment of the structural battery component set forth in the present disclosure. The structural battery component was generally prepared in the same manner as described and illustrated in FIG. 1. In FIG. 2, an anode (A1) comprising an electrode active material of MCMB (B1) is separated from a cathode (A1) comprising an electrode active material of LMO (B2) by a separator (C). The embodiment of FIG. 2 shows two holes going through the width/height of the material and filled with the binding material (i.e. polymer binder). As explained previously, the presence of this binding material enhances structural integrity and improves bonding between layers. In addition to providing enhanced mechanical strength and a binding force between the layers, the binding materials can also be combined with solid state electrolytes (SSE's) to improve the ionic conductivity between electrodes.

Having described certain exemplary embodiments, the specific steps and identity of the various components used in the method are discussed in further detail herein.

The cutting device (e.g., 203) used to cut a portion of the anode, cathode, and/or separator material into the desired shape may be any device suitable for such cutting. In one embodiment, the cutting device is a laser (e.g., femtosecond laser). Femtosecond lasers are renowned for their ability to intricately machine delicate materials due to their ultra-fast pulse length and minimal heat-affected zone. Other ultra-fast lasers may also be used. For example, a short pulse length laser. In other embodiments, the cutting device comprises a nanolaser.

In certain embodiments, the cutting device is a laser and is selected such that it does not melt the separator material or cause thermal degradation of the electrodes during cutting. For example, at least a nanosecond laser.

In other embodiments, the cutting device is a mechanical cutting device.

The cutting device may be used to cut a portion of the anode, cathode, and/or separator material into any desired shape. For example, the anode, cathode, and/or separator material may be cut into the shape of a square, rectangle, triangle, circle, semicircle, wing-shape, etc.

The one or more holes formed in each of the anode, the cathode, and the separator material may be in any configuration or quantity. For example, FIG. 1 shows a wing shaped electrode having a number of evenly spaced holes in all of the structural battery component layers (i.e. both the electrode/anode and the separator material).

The dimensions and configurations of the holes will depend upon the intended use of the product. In an embodiment illustrated in FIG. 1, each of the holes may be approximately 0.5 mm in diameter. For example, about 1.0 mm or less, about 0.75 mm or less, about 0.5 mm or less, about 0.25 mm or less, or about 0.1 mm or less in diameter. The depth of the hole may range from a shallow hole up to a hole that goes through the entire width/height of the cathode, anode, or separator. The dimension and configuration of the holes should be selected such that binding material can be inserted, but not so large as to negatively impact the amount of active material available in the resulting structural battery. That is, in certain embodiments, the size and quantity of the holes are minimized.

As explained above, the holes may be formed, for example by a femtosecond laser. The holes may be formed by any other suitable device, so long as the device forming the holes is of sufficient precision that it does not unduly damage the structural battery component (e.g., a laser). In certain embodiments, the holes may be formed by a cutting device as described above.

The one or more holes formed in each of the anode, the cathode, and the separator material may the same or different. In certain embodiments, the anode, the cathode, and the separator material comprise a plurality of holes. The plurality of holes formed in each of the anode, the cathode, and the separator material may be the same or different. In various embodiments, the one or more holes or plurality of holes in each of the anode, the cathode, and the separator material traverse at least one dimension of the respective component. For example, when the anode, cathode, or separator material are in the form of a sheet, at least one of the holes traverses the width of the anode, cathode, or separator material. That is, at least one of the holes extends through the width such that the hole goes from the top of the anode, cathode, or separator material to the bottom of the anode, cathode, or separator material and produces a cavity.

In one embodiment, the anode, the cathode, and the separator material all comprise at least one identically oriented hole. In another embodiment, the anode, the cathode, and the separator material comprise an identical number and orientation of the one or more holes. It is desirable in some embodiments that they each have at least one identically oriented hole, such that the hole formed in each layer can be oriented with the above/below layers. In this way it is possible to insert a binding material into the aligned holes, thus providing an avenue for increased mechanical strength of the resulting structural battery, as well as an effective electronic path for the electrodes.

In one embodiment, after forming the same holes and patterns in each of the anode, cathode, and separator material, the separator material is placed between the anode and the cathode to form an intermediate structural battery component. Since the holes are, in certain embodiments, identical between each of the anode, cathode, and separator material, the intermediate structural battery component has one or more aligned holes going from the top of the anode through the bottom of the anode, from the top of the separator material through the bottom of the separator material, and from the top of the cathode through the bottom of the cathode. That is, in certain embodiments one or more of the holes traverse the entire width of the intermediate structural battery component. This allows, as described in further detail herein, for a binding material to be placed within the holes of the intermediate structural battery component to form the structural battery component.

In various embodiment, the binding material may be any material that is suitable for binding and does not chemically react with the active materials in the electrodes/electrolyte during cycling. In some embodiments, solid polymer electrolytes (SPEs) may be used. SPEs may act as a binder and also increase the electrochemical performance.

In certain embodiments, the binding material may comprise a polymer. For example, the binding material may be polyvinylidene fluoride (PVDF). Still further embodiments of the binding material comprise a polymer and a solvent.

In some embodiment, the binding material may comprise a thermoplastic component (i.e. thermoplastic resin or polymer) and a solvent component

The solvent may be any solvent suitable for used in a binding material. In some embodiments, the solvent is selected from the group consisting of N-methyl-2-pyrrolidone (NMP), dimethylformamide (DMF), water, and combinations thereof.

In one embodiment, the binding material is a composition of PVDF and a solvent. In another embodiment, the binding material is a composition of PVDF and NMP.

The separator material may be any material suitable for separating electrodes of a structural battery. For example, the separator material may be a polyolefin. In one embodiment, the separator material may be selected from the group consisting of polyethylene, polypropylene, or combinations thereof.

When selecting the separator material, one consideration may be the eventual cutting of the assembled structural battery component. For example, some materials typically selected as a battery separator material may be susceptible to melting or deforming when subjected to a laser for cutting.

In certain embodiments, the structural battery component (e.g., as shown at 401 and also in FIG. 2) may be subjected to a further cutting step to cut the structural battery component into a suitable shape. For example, the structural battery component may be cut into the shape of a square, rectangle, triangle, circle, semicircle, wing-shape, etc.

In other embodiments, one or more holes may be formed in the structural battery component (or cut structural battery component). For example, when assembling a structural battery comprising multiple structural battery components (i.e. multiple battery cells) the discrete structural battery components may be combined in a similar manner as described above. One or more holes are formed in each structural battery component, the structural battery components having holes therein are stacked on one another, and a binder material is placed within the holes to bind the layers of structural battery components together.

As shown in FIG. 3, one or more of structural battery components can be assembled in a casing after being bound together, to form a structural battery.

In one embodiment, a method for preparing a structural battery comprises providing two or more structural battery components, forming one or more holes in each of the two or more structural battery components (e.g., as described elsewhere herein), stacking the two or more structural battery components such that at least one surface of each structural battery component is in contact with at least one surface of another structural battery component, thereby forming a stacked assembly; injecting a binding material into the one or more holes in each of the two or more structural battery components; and placing the stacked assembly within an enclosure, thereby forming the structural battery.

Similar to the assembly of the structural battery components described above, multiple structural battery components may be combined in a single structural battery.

Having described various embodiments of the present disclosure, it will be understood that the described methods and systems enables the fabrication of structural batteries in a wide range of geometries thanks to the additive manufacturing aspect. This allows the structural battery to be employed in many different applications with few modifications between each application. This is particularly useful in industries such as aerospace or automotive where saving space, weight, and customization time contribute to a more economical and efficient product.

### EXAMPLES

### Example 1: Preparation of Carbonized Carbon Fiber Material

A method of preparing a structural battery component was performed.

Carbon fiber mats (i.e. a carbon fiber material) were treated with a layer of carbonizable material prior to casting the active material onto each carbon fiber mat.

Each carbon fiber mat was dip coated in a carbonizable material solution of polyacrylonitrile (PAN) and dimethylformamide (DMF) to coat the carbon fiber in a thin layer of PAN.

The coated carbon fiber mats were dried at a temperature of 200 °C for three hours, then dried for a further three hours under vacuum to evaporate off the DMF. Once the DMF had been removed by evaporation, the coated carbon fiber mats (i.e. coated with a thin layer of PAN) were inserted into a furnace at 600 °C for 3 hours under nitrogen atmosphere to be carbonized. The resulting carbonized carbon fiber material was found to increase the inter-fiber bonding within the mat, increase the overall electrical conductivity of the mat, and improve the interface between the current collector and active material component to be applied.

Preparing a carbonized carbon fiber material (i.e. carbonized carbon fiber mat) in this manner is thought to lead to an improvement in the reliability of and overall capacity of the cells of the structural battery in which such materials are used.

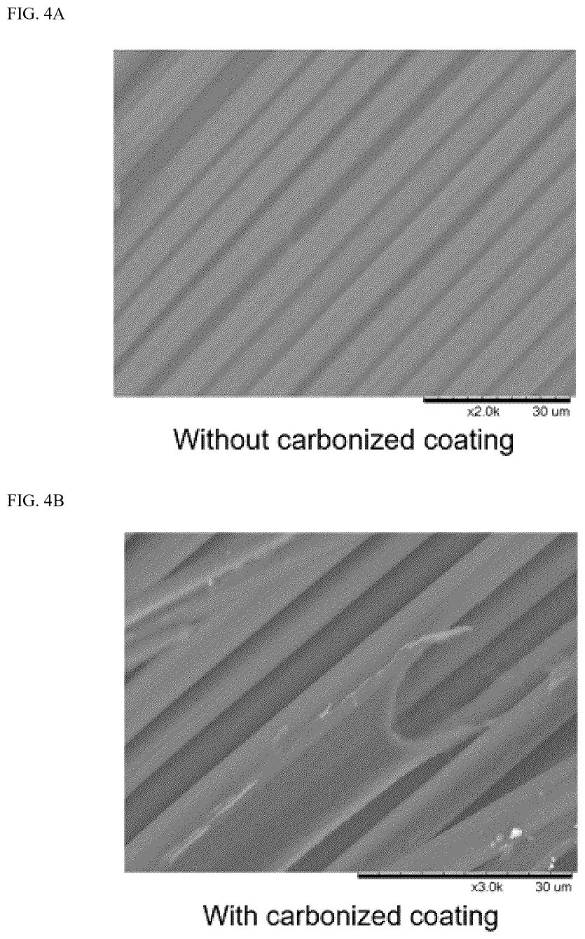

This is further demonstrated through the SEM imaging results set forth in FIG. 4A and FIG. 4B. FIG. 4A shows the SEM imaging results for a carbon fiber mat that was not treated with a layer of carbonizable material prior to casting the active material onto each carbon fiber mat. FIG. 4B shows the SEM imaging results for a carbon fiber mat that was treated with a layer of carbonizable material prior to casting the active material onto each carbon fiber mat (i.e. as described in this example). As can be seen, the carbonized carbon fiber material of FIG. 4B shows greater bonding between the fibers and the mat material.

### Example 2: Preparation of Structural Battery

The carbonized carbon fiber materials described in Example 1 were next coated with an electrode active material on at least one surface.

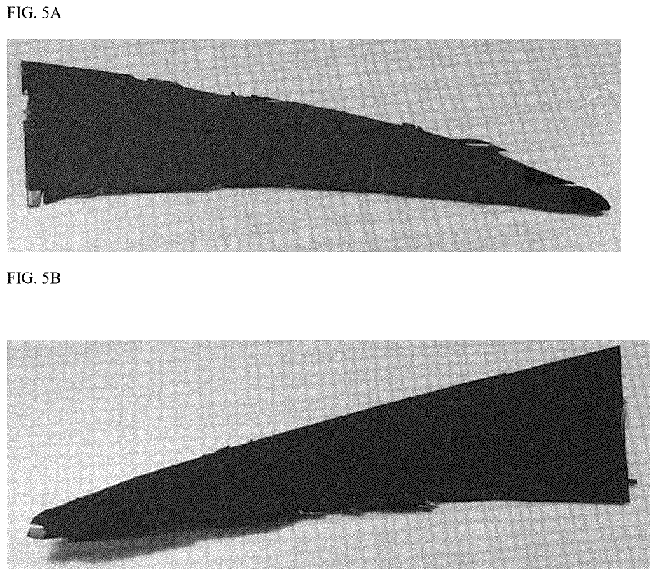

In this example, MCMB was coated on a surface of the anode and LMO was coated on one surface of the cathode. This is illustrated in FIGS. 5A and 5B, with FIG. 5A showing the anode comprising MCMB and FIG. 5B showing the cathode comprising LMO. In each case, the anode/cathode was cut into a wing shape. The electrodes were vacuum dried to evaporate off any remaining solvent.

A structural battery component was then assembled using a femtosecond laser to bind the anode, cathode, and a separator together through intermittently spaced holes in a grid pattern for a binder to penetrate.

Spaced holes were formed in the MCMB-coated anode, the LMO-coated cathode, and a separator material. The spaced holes were approximately 0.5 mm in diameter. The separator material was placed between the MCMB-coated anode and the LMO-coated cathode, and the electrodes and separator were pressed together while a binding material was injected into the spaced holes to form a structural battery component (i.e. a single layer of a battery cell). Following the binding of the electrode pairs and separator, the same femtosecond laser was used to cut out the desired shape for each individual layer of the target geometry (e.g., in a manner as illustrated in step 2 of FIG. 1).

This procedure was repeated for each additional structural battery component that was intended to form the structural battery. Spaced holes were formed in each structural battery component, and the multiple layers of structural battery components were bound together by injecting a binding material (PVDF) into the spaced holes.

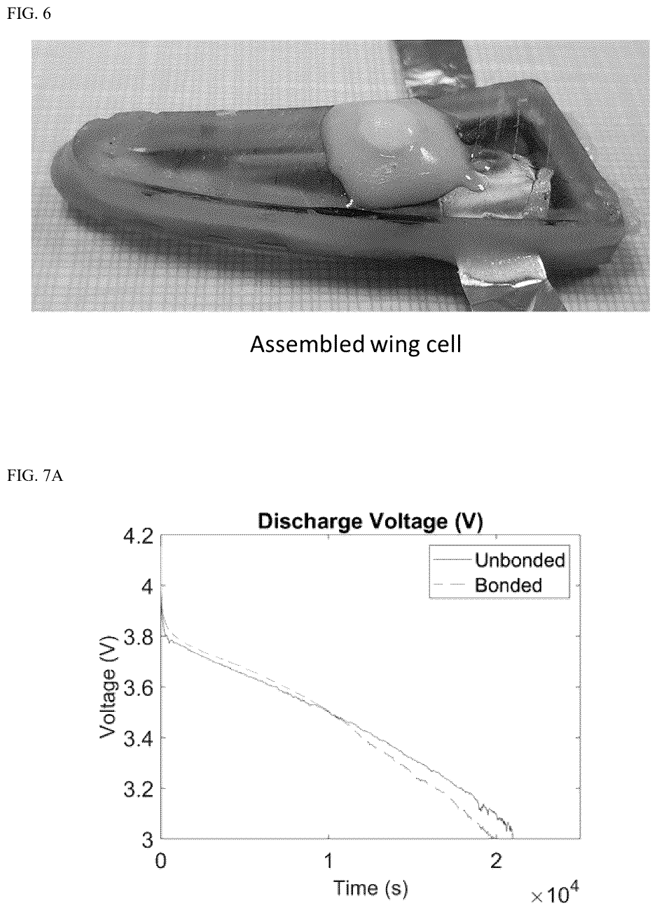

A structural battery was then assembled by placing the structural battery components inside of an enclosure (e.g., pouch cell), attaching anode and cathode current collectors thereto, injecting an electrolyte into the enclosure, and vacuum sealing the enclosure. As shown in FIG. 6, the enclosure was designed to be in a wing shape, such that the entire structural battery was in a wing shape. As detailed herein, the methods of the present disclosure uniquely allow for the individual components (and the assembled structural battery) to be in virtually any desired shape or configuration. This highly customizable method of construction makes the structural batteries described herein valuable in useful for a variety of different situations.

The structural battery of FIG. 6 is shown with a partially clear enclosure for observation during subsequent testing.

### Example 3: Testing of Structural Batteries

Several structural batteries, including those prepared as set forth in Examples 1 and 2, were tested to determine their performance.

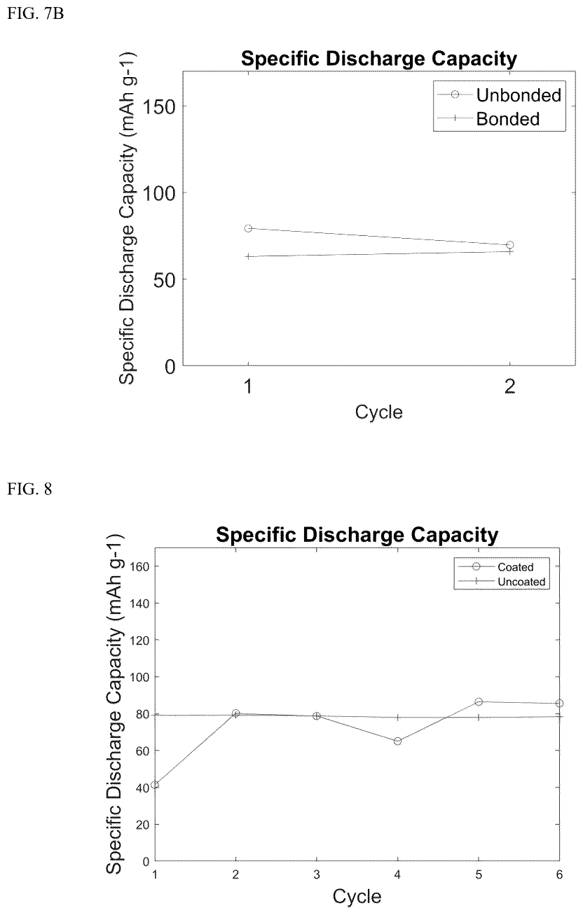

FIG. 7A shows the discharge voltage of two structural batteries. A first “bonded” structural battery was prepared in the manner detailed in Examples 1 and 2. A second “unbonded” structural battery was prepared using a conventional stacking arrangement, wherein spaced holes were not formed in the anode, cathode, or separator material and a binding material was not injected into said spaced holes.

FIG. 7B shows the specific discharge capacity of the bonded and unbonded structural batteries.

FIG. 8 shows the specific discharge capacity of a “coated” structural battery vs. an “uncoated” structural battery. The coated structural battery was prepared in the manner detailed in Examples 1 and 2. The uncoated structural battery did not undergo the steps described in Example 1. That is, the uncoated structural battery did not comprise carbon fiber mats that had been treated with a layer of carbonizable material prior to casting the active material onto each carbon fiber mat.

Having described aspects of the disclosure in detail, it will be apparent that modifications and variations are possible without departing from the scope of the disclosure defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained. As various changes could be made in the above system, processes, and reaction, without departing from the scope of the disclosure, it is intended that all matter contained in the above description and shown in the accompanying drawings shall be interpreted as illustrative and not in a limiting sense.

1. A method for preparing a structural battery component, comprising:
preparing an anode and a cathode, wherein each of the anode and cathode are electrodes prepared by:
placing a carbonizable material on at least one surface of a carbon fiber material, thereby forming an intermediate carbon fiber material;
carbonizing the intermediate carbon fiber material, thereby forming a carbonized carbon fiber material; and
placing an electrode active material on at least one surface of the carbonized carbon fiber material, thereby forming the electrode; and
assembling the structural battery component, wherein assembling the structural battery component comprises:
forming spaced holes in the anode, the cathode, and a separator material;
placing the separator material between the anode and the cathode to form an intermediate structural battery component; and
injecting a binding material into the spaced holes of the intermediate structural battery component to form the structural battery component.

2. The method of claim 1, wherein the carbonizable material is a solution comprising a polymeric component and a solvent component.

3. The method of claim 2, wherein the carbonizable material is a solution comprising polyacrylonitrile (PAN) and dimethylformamide (DMF).

4. The method of claim 1, wherein the electrode active material of the anode is the same or different from the electrode active material of the cathode.

5. The method of claim 1, wherein the electrode active material is selected from the group consisting of lithium manganese oxide (LMO), lithium nickel manganese cobalt oxide (NMC), lithium iron phosphate (LFP), mesocarbon microbeads (MCMB), polyvinylidene fluoride (PVDF), carboxymethyl cellulose (CMC) binder, styrene butadiene rubber (SBR), carbon black, and combinations thereof.

6. The method of claim 1, wherein the binding material comprises a polymer and a solvent component.

7. The method of claim 1, wherein the binding material comprises polyvinylidene fluoride (PVDF) and a solvent selected from the group consisting of N-methylpyrrolidone (NMP), dimethylformamide (DMF), and combinations thereof.

8. The method of claim 1, wherein assembling the structural battery component comprises placing the separator material between the anode and the cathode and then forming the spaced holes in each of the anode, cathode, and separator material.

9. The method of claim 1, wherein assembling the structural battery component comprises:
separately forming the spaced holes in the anode, forming the spaced holes in the cathode, and forming the spaced holes in the separator material; and
placing the separator material between the anode and the cathode such that the spaced holes of each of the anode, cathode, and separator material align.

10. The method of claim 1, wherein the anode, the cathode, and the separator material are each processed to be the same defined shape prior to forming the spaced holes.

11. The method of claim 1, wherein the anode, the cathode, and the separator material are each processed to be the same defined shape after forming the spaced holes.

12. The method of claim 1, wherein the intermediate structural battery component is processed to be a defined shape prior to injecting the binding material into the spaced holes of the intermediate structural battery component.

13. The method of claim 10, wherein the defined shape is selected from the group consisting of a square, rectangle, triangle, circle, semicircle, wing-shape, or combinations thereof.

14. The method of claim 1, wherein forming spaced holes in the anode, the cathode, and the separator material comprises forming the holes via a laser.

15. The method of claim 1, wherein processing the anode, the cathode, and the separator material to be the same defined shape comprises processing via a laser.

16. A method for preparing a structural battery, comprising:
providing two or more structural battery components as set forth in claim 1;
forming spaced holes in each of the two or more structural battery components;
stacking the two or more structural battery components such that at least one surface of each structural battery component is in contact with at least one surface of another structural battery component, thereby forming a stacked assembly;
injecting a binding material into the spaced holes of each of the two or more structural battery components; and
placing the stacked assembly within an enclosure, thereby forming the structural battery.

17. The method of claim 16, wherein each of the two or more structural battery components are processed to be the same defined shape prior to stacking to form the stacked assembly.

18. The method of claim 17, wherein the defined shape is selected from the group consisting of a square, rectangle, triangle, circle, semicircle, wing-shape, or combinations thereof.

19. The method of claim 16, wherein forming spaced holes in each of the two or more structural battery components comprises forming the holes via a short pulse length laser.

20. A structural battery, comprising:
two or more structural battery components within an enclosure;
wherein each structural battery component comprises:
an anode, a cathode, and a separator material, wherein the separator material is between the anode and cathode; and
wherein the anode, the cathode, and the separator material each comprise spaced holes having a binding disposed material therein.
